(19) United States
(12) Patent Application Publication
(10) Pub. No.: US 2025/0319479 A1
(43) Pub. Date: Oct. 16, 2025

(54) SELF-EMPTYING SEPARATOR

(71) Applicant: GEA WESTFALIA SEPARATOR GROUP GMBH, Oelde (DE)

(72) Inventor: Andreas HÖLSCHER, Ennigerloh (DE)

(21) Appl. No.: 18/868,411

(22) PCT Filed: May 5, 2023
(86) PCT No.: PCT/EP2023/062008

§ 371 Date: Nov. 22, 2024

(30) Foreign Application Priority Data
May 25, 2022 (DE) 10 2022 113 293.5

(51) Int. Cl. B04B 1/14; B04B 11/04

(52) U.S. Cl. CPC B04B 1/14; B04B 11/04

(57) ABSTRACT

A self-emptying separator has a rotatable drum, an suspension inlet, a liquid phase outlet, and solids-discharging openings to which an emptying system with a piston slide valve is assigned. The emptying system has a control fluid system assigned to the piston slide valve controlling its opening and closing movements. St least fluid for activating closing movements of the piston slide valve can be directed in a closed conduit system as far as a closing chamber. To supply the closing chamber with the fluid for activating closing movements of the piston slide valve, a pressure vessel is provided upstream of the closing fluid valve and which can be acted upon and can be preloaded with a defined pressure via an additional valve. The control device also determines a drop in pressure in the pressure vessel when the solids-discharging openings are closed.

### BACKGROUND AND SUMMARY OF THE INVENTION

Exemplary embodiments of the invention relate to a self-emptying separator, as well as to a method for processing a centrifugal product.

In addition to one or more drains for one or more liquid phases, discontinuously emptying separators as defined in this document have an emptying system with a piston slide valve that is fluid-actuated, in particular with liquid as fluid, and can be moved alternately into an open and a closed position, wherein the piston slide valve opens (open position) and closes again (closed position) solids-discharge openings in the drum wall. In the open position, a solids phase is discharged from the centrifugal drum.

To ensure the precise functioning of such a drum emptying system of a self-emptying separator, it can have a control fluid system with a piston valve. This is used to fill a chamber on the piston slide valve with fluid-preferably a liquid—and it is used to allow fluid to escape from a chamber on the piston slide valve for emptying solids so that the piston slide valve can move. For example, in a separator with a vertical axis of rotation, fluid can escape underneath a piston slide valve so that the product in the drum pushes it vertically downwards. The aim here is to supply the control fluid system of the centrifugal drum with as precisely measured a volume of fluid as possible in a short time during emptying (“opening fluid”). The volume of the opening fluid thus determines the emptying quantity.

Currently, the control fluid systems of most self-emptying separators are “open”, i.e., both the closing fluid and the opening fluid are sprayed into the rotating drum via control water sprays.

DE 31 15 875 C1, for example, discloses an open control fluid system in which both the closing fluid and the opening fluid are sprayed into the rotating centrifugal drum via control water sprays.

DE 28 22 478 describes a self-emptying separator with a control fluid system in which the control fluid is fed under pressure through a pipe that initially runs centrally in a rotating drive spindle and then radially through the drive spindle into the centrifugal drum.

Like DE 28 22 478, EP 3 207 995 B1 also discloses a self-emptying separator with a control fluid system in which the control fluid is fed through the rotating drive spindle, wherein the feed channel is arranged in a ring around a feed channel for the suspension to be processed, also in order to cool the mechanical seal. The opening fluid is drained through a line that passes axially off-center through the rotor drum or the centrifugal drum rotating during operation and then continues axially, which is almost impossible to implement due to the rotation of the drum.

Control fluid systems according to the prior art have proven themselves in practice. The disadvantage of this system is that leaks in this hydraulic system cannot be easily detected.

Exemplary embodiments of the invention solve this problem.

A self-emptying separator has a rotatable centrifugal drum with a vertical axis of rotation, wherein the centrifugal drum is provided with solids-discharge openings to which an emptying system with a piston slide valve is assigned, which can be moved in a fluid-actuated manner, in particular by means of fluid, into an open position and into a closed position, wherein the emptying system furthermore has a control fluid system assigned to the piston slide valve for controlling its opening and closing movements. This control fluid system in turn has the following:
a control device designed at least for controlling the opening and closing movements,
an opening fluid line in the drum, to which the fluid for activating opening movements of the piston slide valve can be fed from a stationary location that does not rotate during operation via an opening fluid supply in which an opening fluid valve is arranged,
closing chamber, to which the fluid for activating closing movements of the piston slide valve can be fed via a closing fluid supply, in which a closing fluid valve is arranged,
wherein at least the fluid for activating closing movements of the piston slide valve can be conducted into the closing chamber in a closed conduit system,
wherein furthermore, to supply the closing chamber with the fluid for activating closing movements of the piston slide valve, a pressure vessel is provided that is arranged upstream of the closing fluid valve and which can be subjected to a defined pressure and preloaded via an additional valve, and
the control device is furthermore provided at least for determining a pressure drop in the pressure vessel when the solids openings are closed.

Such a self-emptying separator has a whole range of advantages.

The opening and closing fluid (i.e., the fluid that is then used for opening or closing, i.e., the fluid for activating the respective opening or closing movements of the piston slide valve) can be water, for example, or the product or the flowable suspension to be processed, for example.

The determined pressure drop in the pressure vessel when closing fluid is supplied to close the solids-discharge openings can be used to draw a relatively accurate conclusion about the discharged emptying volume and the dosing device for the opening water can then be used to increase or decrease the emptying volume as required in order to achieve the preselected emptying volume. The preselected emptying volume depends on the drum geometry and the process engineering requirements of the centrifuge.

Therefore, if the determined actual value of the volume of emptied solids does not match a set value, the amount of opening water in the dosing device can be adjusted—increased or decreased—for the subsequent emptying.

In the event of total emptying, the closing water valve is closed so that the drum remains open until the drum has emptied completely.

A pressure drop occurring in the preloaded pressure vessel between two partial emptying operations can be used as an indicator of a seal defect on the piston slide valve or drum valve and can be used for leakage monitoring. This is particularly possible because, unlike when the closing water is injected into the rotating centrifugal drum with a type of spray, no volume of the closing fluid can be lost when filling the closing chamber in the rotating system.

According to an optional and advantageous further development, it may be provided that the volume of opening fluid required for opening can be metered with a dosing device.

It is advantageous if both the closing fluid and the opening fluid are preferably fed in a closed and hermetic hydraulic system (lines, valves and the like) from a location outside the rotating system of the separator via a rotary feedthrough into the drive spindle and from there into the rotating drum in the opening fluid line in the drum or the closing chamber. Injection from a non-rotating location into an injection chamber of the rotating centrifugal drum is not necessary. The supply line in the closed system enables a precise supply of a defined volume of fluid into the respective chamber. Losses of fluid during injection are avoided.

Accordingly, the invention also provides the following method: A method for performing a solids partial emptying in a processing of a flowable product with a separator according to one of the preceding claims, characterized by the following method steps:
Step a): Providing a self-emptying separator as described above,
Step b): continuous rotation of the centrifugal drum and continuous processing of a flowable suspension, wherein the suspension is separated centrifugally into at least a liquid phase and a solid phase;
Step c) at intervals-repeated during step b)-emptying of solids through the following sub-steps:
   Sub-step i): Opening the opening fluid valve, so that an opening fluid volume metered by the dosing device is admitted into the opening fluid line in the drum, causing the piston slide valve to move into an open position and the solids openings to be released by the piston slide valve and thereby opened, causing the solids in the centrifugal drum to be emptied;
   Sub-step ii): terminating the emptying of solids by closing the opening fluid valve and opening the closing fluid valve, whereby closing fluid is replenished from the pressure vessel into the closing chamber via the opened closing fluid valve until it is filled and the piston slide valve covers the solids openings of the centrifugal drum, thereby closing the solids openings; and
   Sub-step iii): determining the pressure drop in the pressure vessel when the solids openings are closed.

A change in the pressure drop in sub-step iii) between two partial drains, which in themselves should lead to an equal pressure drop, can in turn be used in a simple way as an indicator for a seal defect, whereby monitoring of a leakage in the rotating system is realized in a simple way.

It is also possible that the volume of emptied solids is determined using the pressure drop determined in step iii), and/or that the emptying quantity for the next emptying is set using a variation of the pressure in the pressure vessel.

For example, the pressure vessel is pressurized to a predetermined pressure between two emptying steps by sub-steps i), ii), and iii) by filling it with a fluid.

### BRIEF DESCRIPTION OF THE DRAWING FIGURES

In the following, the invention is described in more detail with reference to the drawing by means of exemplary embodiments. The invention is not limited to these exemplary embodiments, but can also be realized in other ways according to the wording or in other equivalent ways, wherein:

FIG. 1: shows a schematic sectional view of a separator with a control fluid system according to the invention, as well as a block diagram of the control fluid system; and

FIG. 2: shows a sectional enlargement of a rotary feedthrough of the separator from FIG. 1;

### DETAILED DESCRIPTION

In the following description of the figures, an exemplary embodiment is described. Individual features of this exemplary embodiment can also be combined with exemplary embodiments not shown and are also suitable in each case as advantageous designs of the objects described in individual or several of the main and sub-claims.

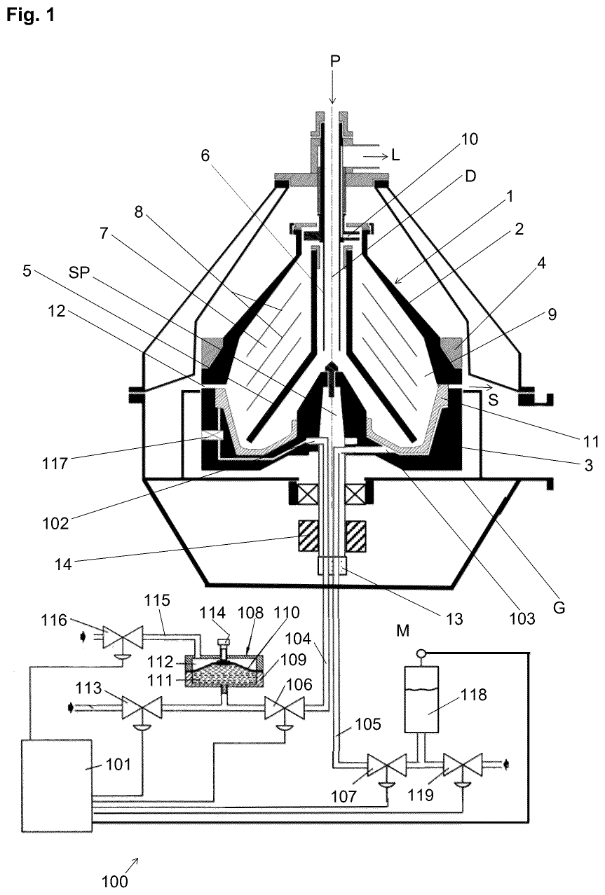

FIG. 1 shows a rotatable centrifugal drum 1 of a centrifuge designed as a self-emptying separator. The centrifugal drum 1 can have a vertical axis of rotation D.

A drive spindle SP for rotating the centrifugal drum 1 is rotatably mounted in a machine frame G. It carries the centrifugal drum 1, which is mounted here on a free end of the drive spindle SP. The drive spindle SP is rotated here by means of a motor 14. Alternatively, other drive variants are also possible.

The centrifugal drum 1 can be single and/or, as in this case, double conical (at the bottom and/or top and in particular on the inside). The centrifugal drum 1 is preferably designed for continuous operation, i.e., for continuous, non-batch centrifugal processing of a flowable suspension.

The centrifugal drum 1 can have an upper drum part 2 and a lower drum part 3. These drum parts 2 and 3 can be connected to each other in various ways, for example with a locking ring 4.

A distributor 5 is formed in the centrifugal drum 1 to feed product from a product feed pipe 6 into a separation chamber 7. The product P is transferred into the rotating system in the distributor 5. The product feed pipe 6 is fed into the centrifugal drum 1 from above or from the end opposite the drive spindle SP.

FIG. 1 shows an example of a so-called clarifier separator, which is designed to clarify a product P (a flowable suspension) to be processed in a centrifugal field or to separate it into a solid phase S and a single liquid phase L.

The actual centrifugal separation of the product P into different phases takes place in the separation chamber 7. The separation chamber 7 preferably has a disk stack 8 consisting of separating disks. It also has a solids collection chamber 9 radially on the outside, in which the solid phase S separated from the suspension or the flowable product P is collected during the separation and/or clarification process.

Furthermore, the separator here has a single liquid discharge 10, via which a liquid phase L can be discharged from the centrifugal drum 1. The liquid discharge 10 is designed here as a so-called paring disk, which operates as a centripetal pump. The liquid discharge 10 can also be realized in another way. Several liquid phases can also be discharged, in which case the centrifugal drum 1 must be provided with a corresponding further discharge system (e.g., with a further paring disk and a separating disk for feeding a further liquid phase to this paring disk, both not shown). The separator is then designed as a so-called separation separator, in which two liquid phases and a solid phase are separated from each other.

A fluid-actuated emptying system is used to discharge the solids phase S from the solids collection chamber 9 of the centrifugal drum 1, which has a piston slide valve 11 for opening and closing a plurality of solids-discharge openings 12, which can be formed circumferentially distributed in the area of the largest diameter of the centrifugal drum 1. The discharge system further comprises a control fluid system 100 associated with the piston slide valve 11 for controlling its opening and closing movements.

The control fluid system 100 has a control device 101. This can be designed as a higher-level control computer for the separator. The control fluid system 100 also comprises an opening fluid line in the drum 102 and a closing chamber 103 in the centrifugal drum 1, to which a fluid, in particular water, can be fed via an opening fluid supply 104 and a closing fluid supply 105, in each of which an opening fluid valve 106 and a closing fluid valve 107 can be arranged, in order to activate the opening and closing movements.

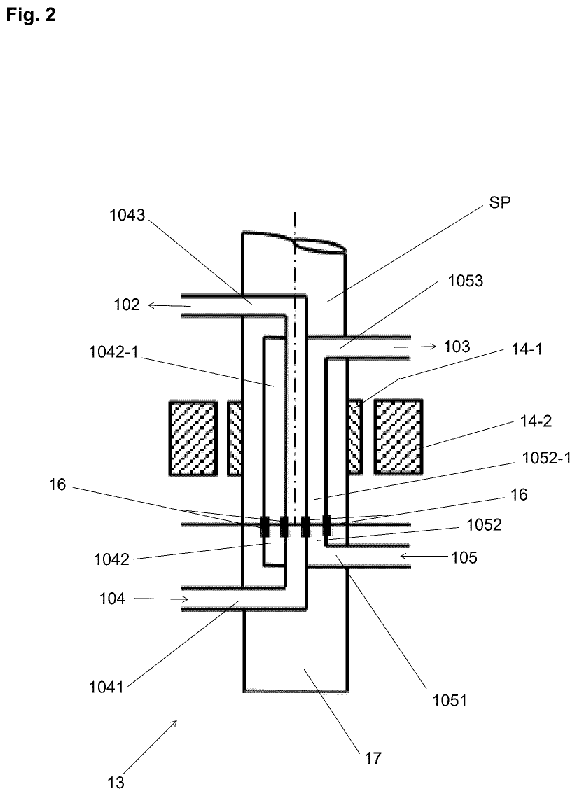

It is advantageous if both the closing fluid and preferably also the opening fluid are preferably conducted in a closed and hermetic hydraulic system (conduits, valves and the like) from a location outside the rotating system of the separator via a sealed rotary feedthrough 13 (see also FIG. 2) into the drive spindle SP and from there into the rotating centrifugal drum 1 into the opening fluid line in the drum 102 or the closing chamber 103.

Injection from a non-rotating location into an injection chamber of the rotating centrifugal drum 1 is therefore not necessary.

The opening fluid supply 104 and a closing fluid supply 105 are each provided from a stationary location outside the elements of the separator rotating during operation-such as the centrifugal drum 1 and the drive spindle SP-through the rotary feedthrough 13 through the drive spindle SP rotating during operation of the separator and then through radial line sections 1043, 1053 into the centrifugal drum 1 rotating at the speed of the drive spindle SP.

The rotary feedthrough 13 makes it advantageously possible to realize a sealed transition of a fluid from stationary supply lines-such as here the opening fluid supply 104 and the closing fluid supply 105—into/out of or through a rotating separator element, such as the drive spindle SP, into the centrifugal drum 2, which rotates at the same speed.

FIG. 2 shows a sectional enlargement of an exemplary rotary feedthrough 13 for the separator from FIG. 1.

The rotary feedthrough 13 is designed here as a two-line rotary feedthrough.

The opening fluid supply 104 and the closing fluid supply 105 into the rotary feedthrough 13 preferably takes place in the radial direction through radial supply line sections 1041, 1051 into a tubular section 17 of the rotary feedthrough 13 which is aligned with the drive spindle SP and does not rotate during operation of the separator.

After entering the radial supply line sections 1041, 1051, the opening fluid and the closing fluid are each guided separately from one another in the tubular section 17 in an axially arranged fluid channel 1042, 1052. The fluid channels 1042, 1052 are coaxial here.

This tubular section 17 is axially adjacent to the drive spindle SP, which rotates during operation and in which the fluid channels 1042, 1052 continue axially or coaxially to one another as fluid channel 1042-1, 1052-1. The respective fluid channel 1042-1, 1052-1 of the drive spindle SP opens into the respective corresponding radial line section 1043, 1053, which emerges from the drive spindle SP in a radial direction.

Seals 16 can be used to seal the transition of the fluid channels 1042, 1042-1 and 1052, 1052-1 between the non-rotating tubular section 17 and the rotating drive spindle SP. The drive spindle SP can in turn be driven by a drive 14, for example. In this case, the rotor 14-1 of the drive 14 is firmly connected to the drive spindle SP and the stator 14-2 of the drive 14 is firmly connected to the housing G.

The opening fluid supply 104 is associated with a dosing device 108, which is connected upstream of the opening fluid valve 106.

The dosing device 108 has a dosing element 110 which is movable, in particular displaceable, in a dosing chamber 109 and which divides the dosing chamber 109 into a fluid chamber 111 and a pressure chamber 112 for the admission of fluid, in particular a gas such as compressed air. The dosing element 110 is designed here as a movable, in particular deformable, diaphragm. The dosing element 110 can also be designed differently.

The fluid chamber 111 is formed between a filling valve 113 and the opening fluid valve 106 as well as an adjusting element 114.

A compressed air line 115, into which a valve 116 is connected, also opens into the pressure chamber 112. A respective control input of all controllable valves can be connected to the control device 101.

A piston valve 117, which is inserted into a wall of the centrifugal drum 1, can serve to discharge the closing fluid (and the opening fluid), in this case controlled by the opening fluid.

In order to keep the solids-discharge openings 12 of the centrifugal drum 1 closed during operation, as shown on the right-hand side of FIG. 1, the closing fluid valve 107 is opened. The closing chamber 103 in the centrifugal drum 1 is supplied with closing fluid via a pressure vessel 118, in which closing fluid is under pressure, which is preloaded via an additional valve 119 and an upstream fluid source (not shown here), such as a pump during filling, so that a defined pressure prevails in the closing fluid system.

The term “preloaded” can mean that the pressure vessel 118 is provided with a defined (excess) pressure via the valve 119 by keeping the valve 119 open during filling until the defined pressure is detected by a suitable measuring device M, which closes the valve 119. This can take place, for example, in the period between two solid emptying operations—i.e., partial emptying.

If partial emptying is carried out to discharge the solids S from the solids collection chamber 9 of the centrifugal drum 1, the opening fluid valve 106 is first opened so that a volume of opening fluid metered by the dosing device 108 is admitted into the opening fluid line 102 in the drum. The opening fluid overcomes the closing force of the piston valve 117, whereby the closing fluid is drained, so that the piston slide valve 11 moves into the opening position and the solids openings 12 are released by the piston slide valve 11 and thereby opened.

When partial emptying is to be completed, the opening fluid valve 106 is closed and the closing fluid valve 107 is opened. This pushes closing fluid from the pressure vessel 118 into the closing chamber 103 via the open closing fluid valve 107 until it is filled and the piston slide valve 11 covers the solids openings 12 of the centrifugal drum 1 and the solids openings 12 are closed.

This results in a pressure drop in the pressure vessel 118, which can be determined, in particular measured by the measuring device M. The amount of the pressure drop in the pressure vessel 118 allows a conclusion to be drawn as to how much closing fluid has been consumed and thus allows an exact statement to be made about the volume of solids emptied by the partial emptying that has taken place. For the next emptying, the pressure vessel 118 is preloaded again via the valve 119 and provided with the defined pressure, which can be detected or measured via the measuring device M.

Using the opening fluid dosing device 108, the volume of solids to be emptied during the next solids emptying operation can be increased or decreased as necessary by comparison with the emptied solids volume determined by the amount of pressure drop of the pressure vessel 118 to achieve a preselected solids volume to be emptied. Accordingly, the dosing device 108 pre-doses a larger or smaller opening fluid volume in the dosing device 108 than for the previous partial emptying operation.

The preselected solids volume depends on the geometry of the centrifugal drum 1 and the process engineering requirements of the separator.

In the event of total emptying, the closing fluid valve 107 is closed so that the centrifugal drum 1 remains open until the centrifugal drum 1 is completely emptied.

A pressure drop occurring in the preloaded pressure vessel 118 between two partial discharges can be used as an indicator for a seal defect on the piston valve 11 or on the piston valve 117 and can be used for leakage monitoring.

Both the closing fluid and the opening fluid are preferably fed in a closed and hermetic hydraulic system from a location outside the rotating system of the separator via the rotary feedthrough 13 into the drive spindle SP and from there into the rotating centrifugal drum 1 into the opening fluid line in the drum 12 or the closing chamber 13. For example, by means of the measuring device M, which can be designed as a pressure monitoring device, it is possible to determine whether there is a leak in this closed system, e.g., in the piston slide valve seal or in the piston valve 117 for draining the closing fluid. The pressure drop during an emptying process of the separator can also be used to determine the emptied solids volume.

The control device 101 can be controlled with a computer program product in the form of a control program, which also takes over the separator control and/or regulation and can thus also control and/or regulate the actuation of the piston slide valve 11, in particular also the dosing of the opening fluid in the dosing device 108 and the preloading of the pressure vessel 118 as well as also the performance and execution of the measurements.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Centrifugal drum
2 Upper drum part
3 Lower drum part
4 Locking ring
5 Distributor
6 Product feed pipe
7 Separation chamber
8 Disk stack
9 Solids collection chamber
10 Liquid discharge
11 Piston slide valve
12 Solids-discharge opening
13 Rotary feedthrough
14 Drive
14-1 Rotor
14-2 Stator
16 Seals
17 Tubular section
100 Control fluid system
101 Control device
102 Opening fluid line in the drum
103 Closing chamber
104 Opening fluid supply
1041 Radial supply line section
1042 Fluid channel
1042-1 Fluid channel
1043 Radial line section
105 Closing fluid supply
1051 Radial supply line section
1052 Fluid channel
1052-1 Fluid channel
1053 Radial line section
106 Opening fluid valve
107 Closing fluid valve
108 Dosing device
109 Dosing chamber
110 Dosing element
111 Fluid chamber
112 Pressure chamber
113 Filling valve
114 Adjusting element
115 Compressed air line
116 Valve
117 Piston valve
118 Pressure vessel
119 Valve
G Machine frame
D Axis of rotation
L Liquid phase
S Solid
SP Drive spindle
P Product
M Measuring device

1-13. (canceled)

14. A self-emptying separator comprising:
a rotatable centrifugal drum with a vertical axis of rotation;
an inlet configured to receive suspension to be processed in a centrifugal field of the rotatable centrifugal drum;
at least one outlet configured to discharge a liquid phase from the rotatable centrifugal drum;
solids-discharge openings configured to discharge a solids phase from the rotatable centrifugal drum; and
an emptying system comprising a piston slide valve that is movable in a fluid-actuated manner into an open position and into a closed position,
wherein the emptying system further comprises a control fluid system configured to control opening and closing movements of the piston slide valve for controlling its opening and closing movements, wherein the control fluid system comprises
a control device configured to control the opening and closing movements of the piston slide valve;
an opening fluid line in the rotatable centrifugal drum, wherein the opening fluid line is configured to be fed, via an opening fluid supply in which an opening fluid valve is arranged, fluid for activating opening movements of the piston slide valve from a stationary location that does not rotate during operation of the rotatable centrifugal drum; and
a closing chamber configured to be fed, via a closing fluid supply, in which a closing fluid valve is arranged, fluid for activating the closing movements of the piston slide valve;
a closed conduit system fluidically coupled to the closing chamber, wherein at least the fluid for activating closing movements of the piston slide valve are conductible into the closing chamber via the closed conduit system; and
a pressure vessel configured to supply the closing chamber with the fluid for activating the closing movements of the piston slide valve, wherein the pressure vessel is arranged upstream of the closing fluid valve and can be subjected to a defined pressure and preloaded via an additional valve,
wherein the control device is further configured to determine a pressure drop in the pressure vessel when the solids openings are closed.

15. The self-emptying separator of claim 14, further comprising:
a dosing device configured to meter a volume of the fluid required to activate opening movements of the piston slide valve.

16. The self-emptying separator of claim 14, wherein both the fluid for activating opening movements and the fluid for activating closing movements are supplied or suppliable in the closed conduit system as far as the opening fluid line in the rotatable centrifugal drum or as far as the closing chamber.

17. The self-emptying separator of claim 14, further comprising:
a measuring device configured to determine pressure in the pressure vessel.

18. The self-emptying separator of claim 15, wherein the dosing device has a dosing element displaceable in a dosing chamber and an adjusting element configured to dose the volume of the fluid required for the opening movement of the piston slide valve.

19. The self-emptying separator of claim 14, wherein the opening fluid supply and the closing fluid supply occur, at least in sections, through a sealed rotary feedthrough through a drive spindle that drives the rotatable drum to rotate during operation of the self-emptying separator.

20. The self-emptying separator of claim 19, wherein the rotary feedthrough is a two-line rotary feedthrough.

21. The self-emptying separator of claim 14, wherein the control device comprises computer control program configured to
control and regulate the self-emptying separator,
control actuation of the piston slide valve and control actuation of a valve,
preload the pressure vessel, and
perform and execute the determination of the pressure drop in the pressure vessel when the solids openings are closed.

22. A method for carrying out a partial discharge of solids when processing a flowable suspension with a self-emptying separator:
a) providing the self-emptying separator, which comprises
a rotatable centrifugal drum with a vertical axis of rotation;
an inlet configured to receive suspension to be processed in a centrifugal field of the rotatable centrifugal drum;
at least one outlet configured to discharge a liquid phase from the rotatable centrifugal drum;
solids-discharge openings configured to discharge a solids phase from the rotatable centrifugal drum; and
an emptying system comprising a piston slide valve that is movable in a fluid-actuated manner into an open position and into a closed position,
wherein the emptying system further comprises a control fluid system configured to control opening and closing movements of the piston slide valve for controlling its opening and closing movements, wherein the control fluid system comprises
a control device configured to control the opening and closing movements of the piston slide valve;
an opening fluid line in the rotatable centrifugal drum, wherein the opening fluid line is configured to be fed, via an opening fluid supply in which an opening fluid valve is arranged, fluid for activating opening movements of the piston slide valve from a stationary location that does not rotate during operation of the rotatable centrifugal drum; and
a closing chamber configured to be fed, via a closing fluid supply, in which a closing fluid valve is arranged, fluid for activating the closing movements of the piston slide valve;
a closed conduit system fluidically coupled to the closing chamber, wherein at least the fluid for activating closing movements of the piston slide valve are conductible into the closing chamber via the closed conduit system; and
a pressure vessel configured to supply the closing chamber with the fluid for activating the closing movements of the piston slide valve, wherein the pressure vessel is arranged upstream of the closing fluid valve and can be subjected to a defined pressure and preloaded via an additional valve,
wherein the control device is further configured to determine a pressure drop in the pressure vessel when the solids openings are closed,
b) rotating the rotatable centrifugal drum and continuously processing the flowable suspension, wherein the flowable suspension is separated centrifugally into at least a liquid phase and a solid phase;
c) at intervals during step b) repeatedly emptying solid through the following sub-steps:
i. opening the opening fluid valve so that the opening fluid volume metered by the dosing device is admitted into the opening fluid line in the rotatable centrifugal drum causing the piston slide valve to move into the opening position and the solids openings to be released by the piston slide valve and thereby opened, and causing the solids of the rotatable centrifugal drum to be emptied;
ii. terminating the emptying of solids by closing the opening fluid valve and opening the closing fluid valve, wherein closing fluid is replenished from the preloaded pressure vessel into the closing chamber via the open closing fluid valve until the closing chamber is filled and the piston slide valve covers the solids openings of the centrifugal drum and the solids openings are thereby closed; and
iii. determining a pressure drop in the pressure vessel when the solids openings are closed.

23. The method of claim 22, wherein a change in the pressure drop in sub-step iii) between two partial drains is used as an indicator for a sealing defect on the piston slide valve or on a piston valve.

24. The method of claim 22, wherein a volume of emptied solids is determined as an actual value using the pressure drop determined in sub-step iii).

25. The method of claim 24, wherein the actual value is compared with a target value and when the actual value of the volume of discharged solid does not correspond to the target value, a quantity of opening water in the dosing device is adjusted for subsequent emptying of the rotatable centrifugal drum.

26. The method of claim 22, wherein the pressure vessel is preloaded to a predetermined pressure by filling it with a fluid.
